(19) United States
(12) Patent Application Publication
(10) Pub. No.: US 2002/0095506 A1
(43) Pub. Date: Jul. 18, 2002

(54) Relay server, communication system and facsimile system

(75) Inventor: Yoshifumi Tanimoto, Uji-shi (JP)

Correspondence Address: HOGAN & HARTSON L.L.P., 500 S. GRAND AVENUE, SUITE 1900, LOS ANGELES, CA, 90071-2611, US

(73) Assignee: MURATA KIKAI KABUSHIKI KAISHA

(21) Appl. No.: 10/045,698

(22) Filed: Jan. 10, 2002

(30) Foreign Application Priority Data
Jan. 15, 2001 (JP) 2001-007049
Jan. 16, 2001 (JP) 2001-007876

(51) Int. Cl. G06F 15/16

(52) U.S. Cl. 709/227; 358/407

(57) ABSTRACT

A facsimile system capable of carrying out a real time facsimile communication by using the Internet even when connecting a facsimile machine is connected to the local system. After connection to a relay server, certification of a first facsimile machine is performed by identifying information, and the connection is maintained. A second facsimile machine makes connection to the relay server in the same manner, and maintains the connection. After allowing communication between the facsimile machines by transmitting, from the first facsimile machine to the relay server, a connection demand with the second facsimile machine, when transmitting the image from the first facsimile machine to the relay server, the relay server relays an image, and the image is transmitted to the second facsimile machine. Since the second facsimile machine is connected to the relay server in advance, the second facsimile machine can receive the image from the relay server.

### CROSS REFERENCES TO RELATED APPLICATIONS

This application claims priority of Japanese Patent Application No.2001-007049, No.2001-007876 filed in JPO on Jan. 15, 2001, Jan. 16, 2001, respectively, the entire disclosures of which are incorporated herein by reference.

### BACKGROUND OF THE INVENTION

1. Field of the Invention

The present invention relates to a communication system wherein a plurality of network devices and relay servers are connected by a network, and the relay servers, which are preferable to be used in such communication system.

2. Description of the Related Art

FIG. 5 is a view useful for explaining an example of a system adopting the general Internet. In the figure, the reference numbers 1, 2 are local systems, 3 is the Internet, 11, 12, 21, 22 are terminals, 13, 23 are gateways, and 14, 24 are LAN. The local system 1 is constructed by the terminal 11, the terminal 12, the gateway 13 or the like being connected by the LAN 14. The gateway 13 is connected to the Internet 3 along with the LAN 14, and one can use the Internet from various network apparatus such as the terminal 11, the terminal 12 or the like on the LAN 14. Moreover, the local system 2 is also constructed in the same manner such that it is constructed by the terminal 21, the terminal 22, the gateway 23 or the like being connected by the LAN 24. The gateway 23 is connected to the Internet 3 along with the LAN 24, and one can use the Internet from various network apparatus such as the terminal 21, the terminal 22 or the like on the LAN 24. Needless to say, in each of the local system 1 and the local system 2, other various apparatus can be connected by the LAN 14 and the LAN 24.

In such system, generally, one global IP address or a plurality of global IP addresses is assigned to the local system 1 and the local system 2, but the global IP address is not necessarily assigned to each network apparatus within the local system 1 and the local system 2. A private IP address is assigned to each network apparatus within each of the local system 1 and the local system 2, and the private IP address is converted into the global IP address by using functions such as NAT or IP masquerade by the gateway 13 and the gateway 23. By using the gateway 13 and the gateway 23 including such IP address converting function, for example in the local system 1, the terminal 11 and the terminal 12 are to use the Internet 3 via the gateway 13. In addition, in the local system 2, the terminal 21 and the terminal 22 are to use the Internet 3 via the gateway 23.

Moreover, the gateway 13, the gateway 23 or other network devices or the like includes a function such as a fire wall or a proxy server, and a structure, in which the respective terminals use the Internet 3 via these devices, is used. In this manner, the safety in the system is improved.

For example, when one attempt to access the terminal 11 within the local system 1 from the Internet 3, the global IP address of the gateway 13 can be learned. However, the private IP address of the terminal 11 cannot be learned. Therefore, in the general connecting method, the terminal 11 cannot be accessed from outside of the local system 1. Moreover, there are cases in which by the function of the fire wall of the gateway 13 for example, the site for accepting the access is limited. Further, it is to be the same manner in the terminal 12, and also in the terminal 21 and the terminal 22 within the local system 2.

Furthermore, the terminal 11 and the terminal 12 within the local system 1, and the terminal 21 and the terminal 22 within the local system 2 are generally provided with only client functions, and are not provided with functions of a server for receiving information from a different network apparatus. Therefore, unless accessing from the terminals 11, 12, 21, 22 to the different network apparatus, the information cannot be transmitted to these terminals from the different network apparatus.

### SUMMARY OF THE INVENTION

The present invention was made in consideration to aforementioned circumstance, and thus the object of the present invention is to provide a communication system wherein a connection to the terminal within the local system from the Internet or the connection between the terminals within different local systems is realized while maintaining the safety of the local system, and a relay server preferable to be used within such communication system.

According to one aspect of the present invention, there is provided a relay server comprising communicating means capable of communicating with a plurality of network devices, and connection information holding means for holding connection information of the network devices which are capable of communicating by the communicating means. Moreover, the communicating means carries out communication with the network devices according to the connection information, and relays data forwarding with the network devices specified according to the connection demand information from the network devices. In the manner stated above, the relay server relays the data forwarding with the network devices being connected thereon. Accordingly, the data can be forwarded even in the case the network device is a terminal within the local system, and the communication can be carried out from the Internet to the terminal within the local system, or between the terminals within different local systems. Moreover, by holding the connection information of the network devices capable of carrying out such relay communication, and by carrying out the communication with the network devices according to the connection information, the connection by the third party can be prevented and the safety of the local system can be maintained.

According to another aspect of the present invention, there are provided a plurality of network devices and the relay server in the communication system which are connected by the network. The network devices establish communication paths with the relay server respectively, and demand connection with other network devices to the relay server when communicating with other network devices. The relay server relays the communication with the network devices and other network devices by using the communication path established in advance with the other network devices. For example, even in the case where the network device is a device whose connection from the outer network is limited such as the terminal connected via a gateway device including an address converting function, since the data is relayed by the relay server wherein these devices are connected capable of communicating, the communication can be carried out between these devices.

### BRIEF DESCRIPTION OF THE DRAWINGS

FIG. 1 is a block diagram showing a communication system including a relay server according to an embodiment of the present invention;

FIG. 2 is a sequence diagram showing an example of the communication procedure of the communication system including the relay server shown in FIG. 1;

FIG. 3 is a block diagram showing a facsimile system according to another embodiment of the present invention;

FIG. 4 is a sequence diagram showing an example of the communication procedure of the facsimile system shown in FIG. 3; and

FIG. 5 is a view useful for describing an example of the system using the general Internet.

### DETAILED DESCRIPTION OF THE INVENTION

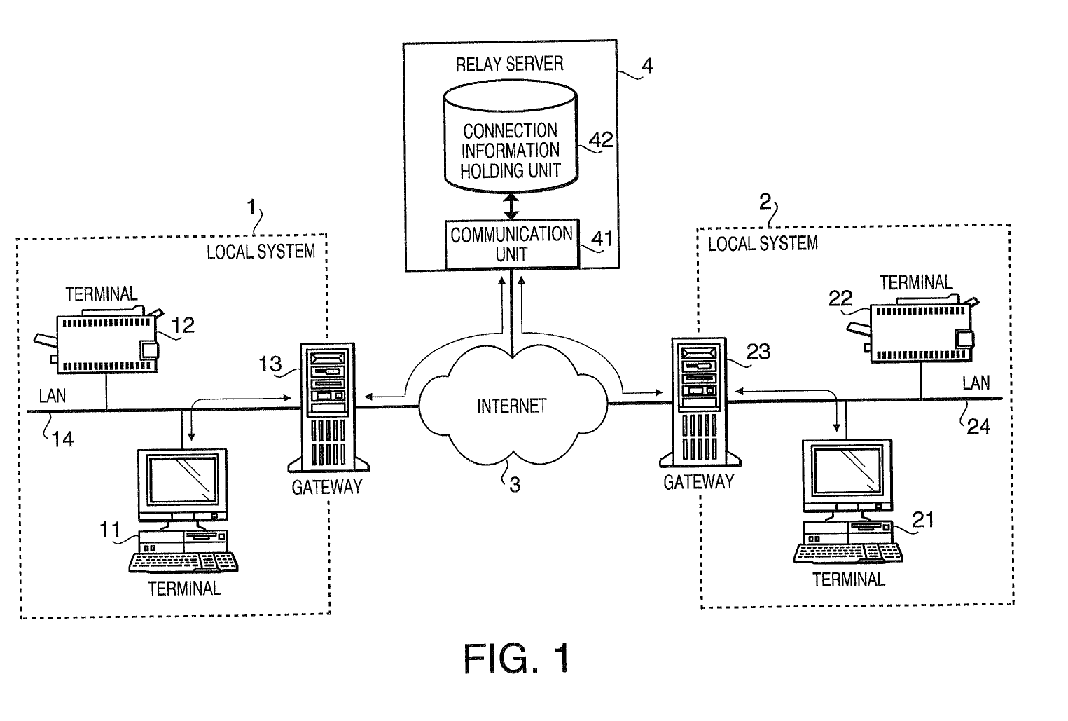

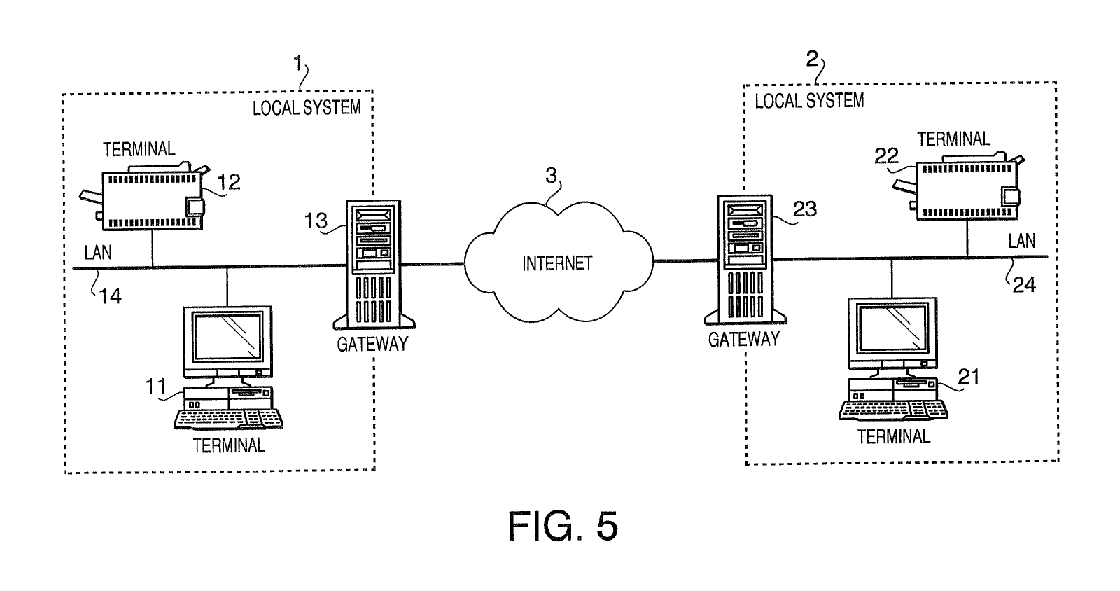

In FIG. 1, for the same part as the part of FIG. 5, the same reference number is to be applied and the repetitive description will be abbreviated. The reference number 4 is a relay server, 41 is a communication unit, and 42 is a connection information holding unit. The relay server 4 is connected to the Internet 3, and includes a global IP address. By accepting a log-in demand to the global IP address from the network apparatus, the connection with the network apparatus is to be maintained and the communication path is to be maintained. Such connection is to be maintained with a plurality of network apparatus. Then, when forwarding the data from a first network apparatus to a second network apparatus, the relay server 4 receives the data by using the communication path between the first network apparatus and the relay server 4, and the relay server 4 further transmits the data by using the communication path between the relay server 4 and the second network apparatus. By relaying the communication between the first network apparatus and the second network device in such a manner, the communication between the first network apparatus and the second network apparatus can be realized.

For example, although the connection can be made from the relay server 4 to the gateway 13 within the local system 1, it cannot be connected to the terminal 11 or the terminal 12. However, by using the global IP address of the relay server 4, it can be connected to the relay server 4 from the terminal 11 or the terminal 12 via the gateway 13. Therefore, by demanding log-in to the relay server 4 from the terminal 11 or the terminal 12, the communication in both directions can be carried out between the relay server 4 and the terminal 11 or the terminal 12 which demanded the log-in. In the same manner, although the connection can be made from the relay server 4 to the gateway 23 within the local system 2, it cannot be connected to the terminal 21 or the terminal 22. However, by using the global IP address of the relay server 4, the connection can be made to the relay server 4 via the gateway 23 from the terminal 21 or the terminal 22. Therefore, by demanding log-in from the terminal 21 or the terminal 22 to the relay server 4, the communication in both directions can be carried out between the relay server 4 and the terminal 21 or the terminal 22 which demanded the log-in. Further, as it has been described by referring to FIG. 5, the communication cannot be carried out directly between the terminal 11 or the terminal 12, and the terminal 21 or the terminal 22.

For example, when the communication path is established by the terminal 11 within the local system 1 and the terminal 21 within the local system 2 demanding log-in to the relay server 4, the relay server 4 is capable of carrying out the communication in both directions with the terminal 11, and the communication in both direction with the terminal 21. When the relay server 4 receives a communication demand from the terminal 11 to the terminal 21, the relay server 4 receives the data transmitted from the terminal 11 and transmits the received data to the terminal 21. The data forwarding from the terminal 11 to the terminal 21 is carried out. On the contrary, the relay server 4 is also capable of receiving the data transmitted from the terminal 21 and then transmitting the received data to the terminal 11. In such a manner, the communication between the terminal 11 and the terminal 21 can be realized.

The relay server 4 can be constructed by including such as the communication unit 41 and the connection information holding unit 42. The communication unit 41 is capable of communicating with a plurality of network devices via the Internet 3. In addition, when the communication unit 41 receives the connection demand information from the network device which is connected capable of communicating, according to the connection demand information, the communication unit 41 relays the data forwarding between the network device which is connected capable of communicating and the network device which demanded the connection. For example, when the terminal 11 and the terminal 21 are connected capable of communicating by the communication unit 41 respectively and the connection demand information with the terminal 21 is received from the terminal 11, the data forwarding is carried out between the terminal 11 and the communication unit 41, and also the data forwarding is carried out between the communication unit 41 and the terminal 21, to realize the communication between the terminal 11 and the terminal 21 substantially. A plurality of connections with one network device can be maintained and the communication with a plurality of network devices can be carried out by using a plurality of connections.

The connection information holding unit 42 is holding the connection information of the network device capable of communicating by the communication unit 41, and is used for certification when carrying out the communication by the communication unit 41 being connected to the network device. The connection information includes for example, a user ID and a password. The certification is carried out by receiving the information of the user ID and the password when receiving the connection from the network device, and it can be determined whether or not to carry out the communication. Moreover, for example, various setting information for the communication can be included in the connection information. Furthermore, in the case of carrying out another relay of the data forwarding with a different network device by receiving the connection demand information from the network device which is connected capable of communicating, the current relaying information can also be held by the connection information holding unit 42.

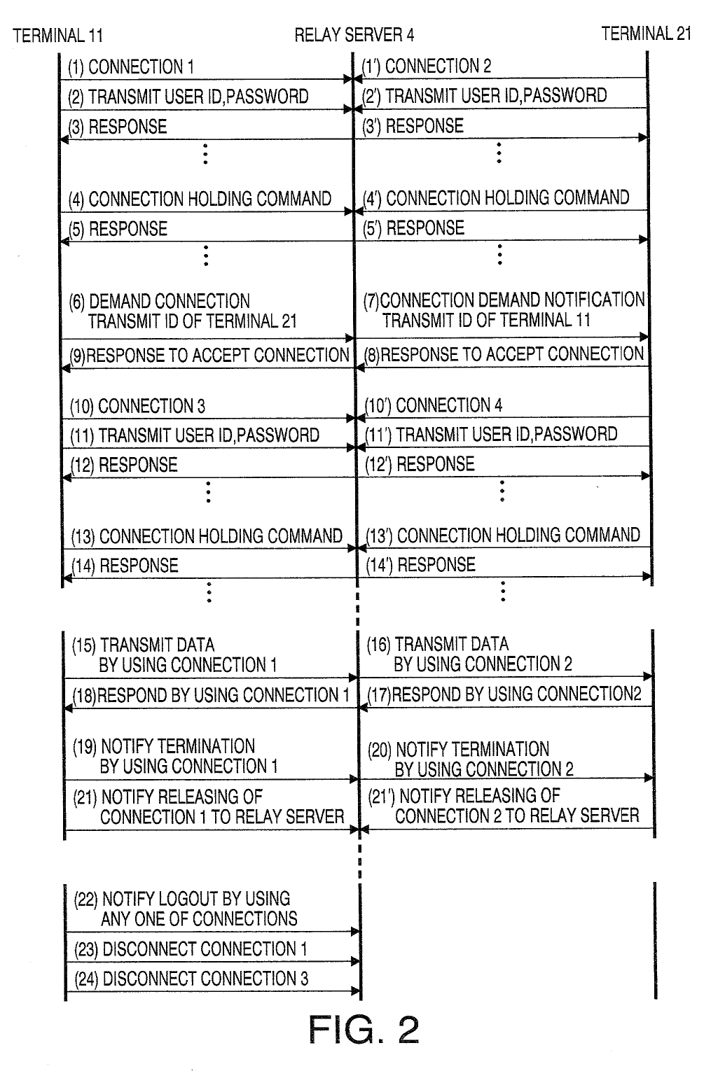

The communication procedure shown in FIG. 2 is carried out by using TCP/IP, and also includes, for example, the connection with the relay server 4, the maintenance of the connection, the connection demand to the terminal, the data forwarding to the terminal, the termination of the connection with the terminal, and the termination of the connection with the relay server. As an example, it is shown of the case in which the communication is carried out between the terminal 11 within the local system 1 and the terminal 21 within the local system 2 of FIG. 1. The terminal 11 and the terminal 21 are to be registered as a user to the relay server 4 in advance For the information of registration, there are for example, the user ID and the password. These pieces of information are to be held as the connection information by the connection information holding unit 42.

When the terminal 11 is directed after being started or by an operator for example, in the process (1) of FIG. 2, the terminal 11 is connected to the relay server 4 via the gateway 13, performs log-in, and establishes TCP/IP connection (connection 1) with the relay server 4. Since the terminal 11 is a network device within the local system 1, the communication cannot be carried out directly from the relay server 4, but the connection can be made to the relay server 4 by the log-in from the terminal 11 which is a client. Since TCP/IP connection is capable of data communication in both directions, the communication can be carried out from the terminal 11 to the relay server 4, or from the relay server 4 to the terminal 11.

After the connection 1 is established, in the process (2), the terminal 11 transmits the user ID and password to the relay server 4. The relay server 4 checks whether or not the received user ID and the password are held as the connection information in the connection information holding unit 42, and carries out the certification of the terminal 11. By this certification, the connection with an unspecified third party can be prevented, and the safety can also be secured. In the case of failing to make the certification in that the connection information is not registered or that the password is not correct for example, the relay server 4 carries out negative response to the terminal 11, or disconnects the connection 1 directly. When the certification is succeeded, in the process (3), positive response is carried out and until the connection 1 is disconnected, the relay server 4 controls the connection 1 to be maintained.

When TCP/IP connection with the relay server 4 is established and the certification is obtained, to maintain the connection (connection 1), in the process (4), a command to hold the connection is transmitted to the relay server 4 periodically, and in the process (5), the response of confirmation is obtained from the relay server 4. The connection is to be held accordingly, and it is confirmed that the relay server 4 is operating normally.

As in the same manner, in the process (1′), the terminal 21 makes connection to the relay server 4 via the gateway 23, performs log-in, and establishes TCP/IP connection (connection 2) with the relay server 4. Since the terminal 21 is also the network device within the local system 2, the communication cannot be carried out directly from the relay server 4, but the connection can be made to the relay server 4 by the log-in from the terminal 21 which is the client . By the connection 2, the communication can be carried out from the terminal 21 to the relay server 4, or from the relay server 4 to the terminal 21.

After the connection 2 is established, in the process (2′), the terminal 21 transmits the user ID and the password to the relay server 4. The relay server 4 checks whether or not the received user ID and the password are held as the connection information in the connection information holding unit 42, and carries out the certification of the terminal 21. In the case of failing to make certification in that the connection information is not registered or that the password is not correct for example, the relay server 4 carries out negative response to the terminal 21, or disconnects the connection 2 directly. When the certification is succeeded, in the process (3′), positive response is carried out and until the connection 2 is disconnected, the relay server 4 controls the connection 2 to be maintained.

When TCP/IP connection with the relay server 4 is established and the certification is obtained, to maintain the connection (connection 2), in the process (4′), the command for holding the connection is transmitted to the relay server 4 periodically, and in the process (5′), the response of confirmation is obtained from the relay server 4. The connection is to be held accordingly, and it is confirmed that the relay server 4 is operating normally.

Further, the connection between the terminal 11 and the relay server 4, and the connection between the terminal 21 and the relay server 4, can be carried out at any time if it is before the two communications are carried out. Moreover, it is necessary that the connection with the relay server 4 is maintained until the two communications are started.

When a demand is generated in that the connection is to be made from the terminal 11 to the terminal 21, in the process (6), the terminal 11 specifies the user ID of the terminal 21 to demand the connection, and demands the connection to the relay server 4. Further, the user ID of the terminal 21, which is to be the connection destination, can be specified by any method such as obtaining in advance or specifying by confirming to a list or the like of the users in the log-in state from the relay server 4. When the terminal 21 corresponding to the specified user ID is not in the log-in state, the relay server 4 returns the error to the terminal 11. Moreover, when the terminal 21 is under the log-in state, in the process (7), the relay server 4 transmits a connection demand notification including the information that there is a connection demand to the terminal 21, and the user ID of the terminal 11 which is demanding the connection.

The terminal 21 memorizes that the connection used for the transmission of the connection demand notification is used in the connection with the terminal 11, and in the process (8), responds that it is acceptable. Further, when rejecting a connection, the terminal 21 sends back an error. In the process (9), the relay server 4 sends back the response from the terminal 21 to the terminal 11. When the response from the terminal 21 is a response of acceptability, the relay server 4 memorizes that the connection 1 and the connection 2 are to be used in the communication between the terminal 11 and the terminal 12 respectively. Moreover, in the terminal 11 which received the response from the terminal 21, when receiving the response of acceptability, the connection in use (connection 1) is memorized as the connection to be used in the communication with the terminal 21.

When it is confirmed of carrying out the communication between the terminal 11 and the terminal 21 in the manner stated above, the data is to be transmitted actually after the process (15). Further, in the example shown in FIG. 2, after it is decided that the communication is to be carried out between the terminal 11 and the terminal 21, for receiving the connection demand from a different network apparatus and for carrying out the connection demand to a different network apparatus, a new TCP/IP connection is to be established to the relay server 4 respectively. In other words, in the process (10), the terminal 11 performs the log-in to the relay server 4 to establish TCP/IP connection (connection 3) with the relay server 4, and in the process (11), the terminal 11 transmits the user ID and the password to the relay server 4. The relay server 4 carries out the certification of the terminal 11 by the received user ID and password, and in the process (12), sends back the response. Then, to maintain the connection 3, in the process (13), the connection holding command is transmitted to the relay server 4 from the terminal 11 periodically, and in the process (14), the relay server 4 sends back the response to the terminal 11. As in the same manner, in the process (10′), the terminal 21 performs the log-in to the relay server 4 to establish TCP/IP connection (connection 4) with the relay server 4, and in the process (11′), the terminal 21 transmits the user ID and the password to the relay server 4. The relay server 4 carries out the certification of the terminal 21 by the received user ID and the password, and in the process (12′), sends back the response. Then, to maintain the connection 4, in the process (13′), the connection holding command is transmitted to the relay server 4 from the terminal 21 periodically, and in the process (14′), the relay server 4 sends back the response to the terminal 21. Further, in the case it is not necessary to maintain such vacant connection, the processes of (10)˜(14), or (10′)˜(14′) is not necessary. Moreover, in the case where a plurality of connections has already been secured, these procedures are not required to be carried out.

When it is confirmed of carrying out the communication between the terminal 11 and the terminal 21 by the procedure of the processes (6)˜(9), in the process (15), the terminal 11 transmits the data to the terminal 21 by using the connection 1 to the relay server 4. The relay server 4 receives the data from the terminal 11, and in the process (16), transmits the received data to the terminal 21 by using the connection 2. The terminal 21 receives the data from the terminal 11 by being transmitted from the relay server 4 through the connection 2, and in the process (17), transmits the response directed to the terminal 11 to the relay server 4. The relay server 4 receives the response directed to the terminal 11 from the terminal 21, and in the process (18), transmits the received response to the terminal 11 through the connection 1.

As in the manner stated above, by using the connection 1 between the terminal 11 and the relay server 4, and the connection 2 between the terminal 21 and the relay server 4, by relaying the data by the relay server 4, the communication can be carried out between the terminal 11 and the terminal 21. Further, the data forwarding to the terminal 21 from the terminal 11 by the processes (15)˜(18) can be repeated several times. Moreover, the data can be forwarded from the terminal 21 to the terminal 11.

When the data forwarding between the terminal 11 and the terminal 21 is completed, the termination notification is carried out from the terminal 11 or the terminal 21. It is to be supposed that the termination notification is carried out from the terminal 11, and in the process (19), the terminal 11 transmits the termination notification to the terminal 21, to the relay server 4 by using the connection 1. The relay server 4 transmits the termination notification to the terminal 21 received from the terminal 11 to the terminal 21 by using the connection 2 in the process (20). Then in the process (21), the terminal 11 which transmitted the termination notification transmits, to the relay server 4, the releasing notification indicating that the connection 1 has become vacant. Moreover, in the process (21′), the terminal 21 which received the termination notification also transmits to the relay server 4, the releasing notification indicating that the connection 2 has become vacant. Accordingly, the relay server 4 memorizes that the connection 1 and the connection 2 are not to be used in the communication between the terminal 11 and the terminal 21, and that the connections have become vacant. Further, in this example, the response to the termination notification is not carried out, but it may be made to send back the response.

The connection 1 and the connection 2 which were released in such a manner are maintained. That is, by carrying out the connection holding command and the response periodically as shown in the process (4), (5), or (4′), (5′), the connection is maintained between the terminal 11 and the relay server 4, and between the terminal 21 and the relay server 4.

Further, at the time being, the connection 1 and the connection 3 are secured between the terminal 11 and the relay server 4. As in the same manner, the connection 2 and the connection 4 are secured between the terminal 21 and the relay server 4. This can be left in this state or the connection 1 and the connection 2 can be disconnected when releasing these connections. Moreover, the connection 1 and the connection 2 can be continued and the connection 3 and the connection 4 can be disconnected.

When the terminal 11 shuts the power source or when stopping the connection to the relay server 4, in the process (22), the terminal 11 notifies the log-out to the relay server 4. At the time being, when a plurality of connections are secured, any connection can be used. Then, the terminal 11 disconnects all the connections to complete. In this example, in the process (23), the connection 1 is to be disconnected to complete and in the process (24), the connection 3 is to be disconnected to complete. The relay server 4 receives the notification of the log-out from the terminal 11, recognizes the log-out of the terminal 11 and disconnects all the connection (connection 1, and connection 3) with the terminal 11. Further, it is also the same in the terminal 21.

By carrying out the procedure described above, even in the case where each of or one of the apparatus is the network apparatus within the local system, the communication can be carried out. Further, the procedure for carrying out the connection with the relay server 4 as described above, the maintenance of the connection, the connection demand to the terminal, the data transmission to the terminal, the termination of the connection with the terminal, the termination of the connection with the relay server 4, can be realized not to give any influence while transparency of the command or the data to be exchanged by an application protocol working in the upper state is maintained, and the communication can be carried out by using the existing application protocol as it is.

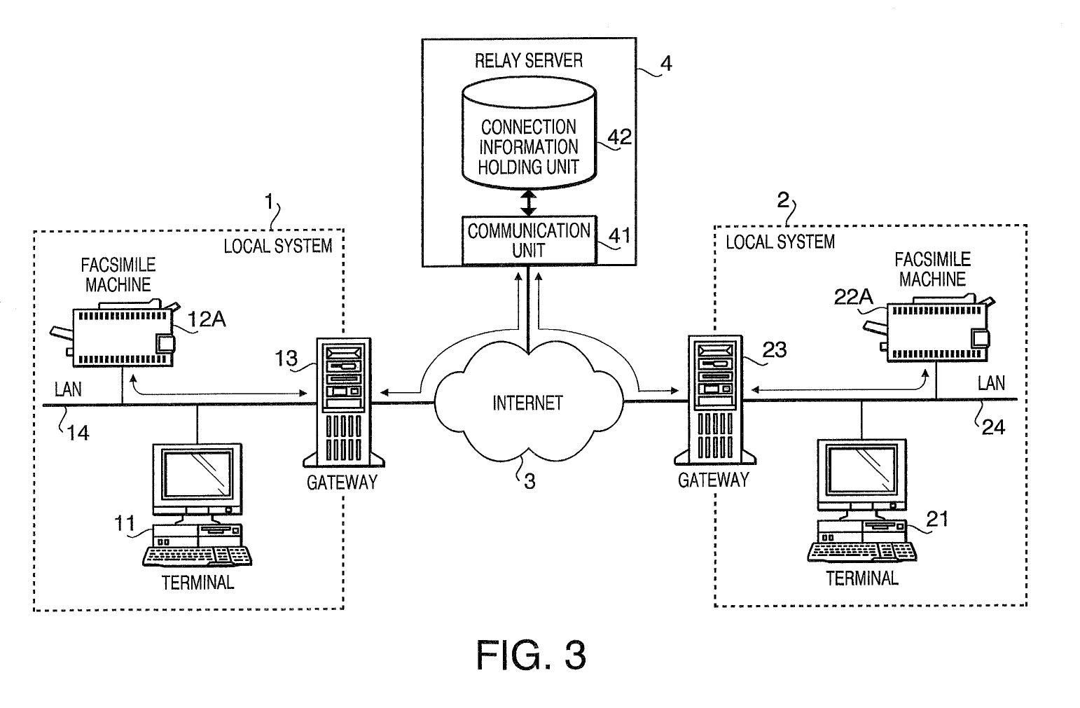

In FIG. 3, for the same part with FIG. 5, same reference number is to be applied and the repetitive description will be abbreviated. Reference number 4 is a relay server, 41 is a communication unit, and 42 is a connection information holding unit. The relay server 4 is connected to the Internet 3, and includes a global IP address. The relay server 4 receives the log-in demand to the global IP address from a facsimile machine, and secures the communication path by maintaining the connection with the facsimile machine. Such connection is to be maintained with a plurality of facsimile machines. Then, when transmitting facsimile from a first facsimile machine to a second facsimile machine, the relay server 4 receives an image by using the communication path between the first facsimile machine and the relay server 4, and the relay server 4 further transmits the image by using the communication path between the relay server 4 and the second facsimile machine. By relaying the communication between the first facsimile machine and the second facsimile machine in such a manner, the communication can be realized between the first facsimile machine and the second facsimile machine.

For example, although the connection can be made from the relay server 4 to the gateway 13 within the local system 1, the connection cannot be made to the terminal 11 or a facsimile machine 12A. However, when using the global IP address of the relay server 4, the connection can be made to the relay server 4 from the terminal 11 or the facsimile machine 12A via the gateway 13. Therefore, by carrying out the log-in demand to the relay server 4 from the facsimile machine 12A, the communication can be carried out in both directions between the relay server 4 and the facsimile machine 12A which carried out the log-in demand. In the same manner, although the connection can be made from the relay server 4 to the gateway 23 within the local system 2, the connection cannot be made to the terminal 21 or a facsimile machine 22A. However, when using the global IP address of the relay server 4, the connection can be made to the relay server 4 from the terminal 21 or the facsimile machine 22A via the gateway 23. Therefore, by carrying out the log-in demand to the relay server 4 from the facsimile machine 22A, the communication can be carried out in both directions between the relay server 4 and the facsimile machine 22A which carried out the log-in demand. Further, as it has already been described by referring to FIG. 5, the communication cannot be carried out directly between the facsimile machine 12A and the facsimile machine 22A.

For example, when the facsimile machine 12A within the local system 1 and the facsimile machine 22A within the local system 2 carry out the log-in demand to the relay server 4 and the communication path is established, the relay server 4 is capable of carrying out the communication in both directions with the facsimile machine 12A, and the communication in both directions with the facsimile machine 22A. When receiving a communication demand to the facsimile machine 22A from the facsimile machine 12A, the relay server 4 receives the image transmitted from the facsimile machine 12A, and transmits the received image to the facsimile machine 22A. Accordingly, the facsimile communication from the facsimile machine 12A to the facsimile machine 22A is carried out. On the other hand, the relay server 4 is capable of receiving the image transmitted from the facsimile machine 22A, and transmitting the received image to the facsimile machine 12A. As in such a manner, the facsimile communication can be realized between the facsimile machine 12A and the facsimile machine 22A.

The relay server 4 can be constructed by including such as the communication unit 41 and the connection information holding unit 42. The communication unit 41 is capable of communicating with a plurality of facsimile machines via the Internet 3. In addition, when the communication unit 41 receives the connection demand information from the facsimile machine which is connected capable of communicating, following the connection demand information, the communication unit 41 relays the forwarding of the image between the facsimile machine which is connected capable of communicating and the facsimile machine which demanded the connection. For example, when the facsimile machine 12A and the facsimile machine 22A are connected capable of communicating by the communication unit 41 respectively, and the communication unit 41 receives the connection demand information with the facsimile machine 22A from the facsimile machine 12A, the image is forwarded between the facsimile machine 12A and the communication unit 41 and the image is also forwarded between the communication unit 41 and the facsimile machine 22A, and as a result, the communication can be carried out substantially between the facsimile machine 12A and the facsimile machine 22A. It is possible to secure a plurality of connections with one facsimile machine, and the communication can be carried out with a plurality of facsimile machines by using a plurality of connections.

The connection information holding unit 42 holds the connection information of the facsimile machine which is capable of communicating by the communication unit 41, and can be used in the certification when the communication unit 41 carries out the communication by being connected to the facsimile machine, and in the check of the connection condition. The connection information includes identification information such as the user ID and the password, and when receiving the connection demand from the facsimile machine, the certification can be carried out by receiving the identification information such as the user ID and the password, and it is determined whether or not the communication can be carried out. Moreover, various setting information or the like for the communication can be included in the connection information. Furthermore, information such as whether or not the communication path is secured by the registered facsimile machine in the log-in state, or whether or not the communication is being carried out with a different facsimile machine, can be held as the connection condition.

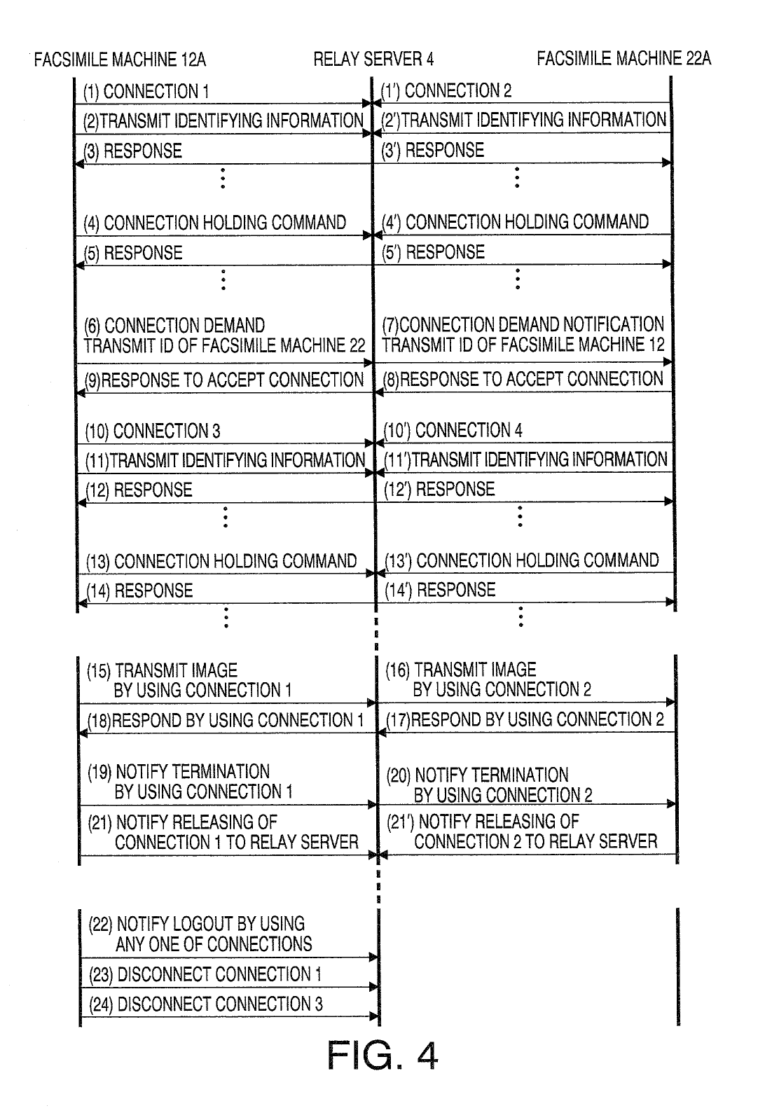

The communication procedure shown in FIG. 4 is carried out by using TCP/IP, and carries out for example, the connection with the relay server 4, the maintenance of the connection, the demand of connection to the facsimile machine, the data forwarding to the facsimile machine, the termination of connection with the facsimile machine, and the termination of connection with the relay server. As an example, it is shown of a case in which the communication is carried out between the facsimile machine 12A within the local system 1 and the facsimile machine 22A within the local system 2 of FIG. 3. The facsimile machine 12A and the facsimile machine 22A are registered in the relay server 4 as the user in advance. For the information of registration, there are the user ID and the password as the identifying information. This identifying information is held by the connection information holding unit 42 as a part of the connection information.

When the facsimile machine 12A is directed after being started or by the operator for example, in the process (1), the facsimile machine 12A makes connection to the relay server 4 via the gateway 13, performs the log-in, and establishes TCP/IP connection (connection 1) with the relay server 4. Since the facsimile machine 12A is a network device within the local system 1, it cannot be accessed directly from the relay server 4, but by the log-in from the facsimile machine 12A, the connection to the relay server 4 can be made. Since the TCP/IP connection is capable of data communication in both directions, when the facsimile machine 12A and the relay server 4 are connected, the communication can be carried out from the facsimile machine 12A to the relay server 4, and from the relay server 4 to the facsimile machine 12A.

After the connection 1 is established, in the process (2), the facsimile machine 12A transmits the identifying information such as the user ID and the password to the relay server 4. The relay server 4 checks whether or not the identifying information such as the received user ID or the password are held as the connection information in the connection information holding unit 42, and then carries out the certification of the facsimile machine 12A. By such certification, the connection to an unspecified third party is prevented, and the safety of the local system can be secured. In the case of failing in the certification, such that the identifying information is not registered as connection information or that the password is not correct, the relay server 4 carries out the negative response to the facsimile machine 12A or disconnects the connection 1. When the certification succeeds, in the process (3), the positive response is made, and until the connection 1 is disconnected, the relay server 4 controls the connection 1 to be maintained.

When the TCP/IP connection with the relay server 4 is established and the certification is obtained, to hold the connection (connection 1), in the process (4), the facsimile machine 12A transmits the command of connection holding to the relay server 4 periodically, and in the process (5), obtains the response of confirmation from the relay server 4. The connection is held and it is confirmed that the relay server is operating normally.

As in the same manner, in the process (1′), the facsimile machine 22A makes connection to the relay server 4 via the gateway 23, performs log-in, and establishes the TCP/IP connection (connection 2) with the relay server 4. Since the facsimile machine 22A is also the network device within the local system 2, it cannot be accessed directly from the relay server 4, but by the log-in from the facsimile machine 22A, the connection to the relay server 4 can be made. The communication can be carried out by the connection 2 from the facsimile machine 22A to the relay server 4, and from the relay server 4 to the facsimile machine 22A.

After the connection 2 is established, in the process (2′), the facsimile machine 22A transmits the identifying information such as the user ID and the password to the relay server 4. The relay server 4 checks whether or not the identifying information such as the received user ID or the password is held as the connection information in the connection information holding unit 42, and then carries out the certification of the facsimile machine 22A. In the case of failing in the certification, such that the identifying information is not registered as connection information or that the password is not correct, the relay server 4 carries out the negative response to the facsimile machine 22A or disconnects the connection 2. When the certification succeeds, in the process (3′), the positive response is made, and then until the connection 2 is disconnected, the relay server 4 controls the connection 2 to be maintained.

When the TCP/IP connection with the relay server 4 is established and the certification is obtained, to hold the connection (connection 2), in the process (4′), the facsimile machine 22A transmits the command to hold the connection to the relay server 4 periodically, and in the process (5′), obtains the response of confirmation from the relay server 4. The connection is held and it is confirmed that the relay server is operating normally.

Further, the connection between the facsimile machine 12A and the relay server 4, and the connection between the facsimile machine 22A and the relay server 4, can be carried out at any time if it is before the facsimile communication of the two is carried out. Moreover, it is necessary that the connection with the relay server 4 is maintained until the two facsimile communications are started.

When a demand is generated in that the connection is to be made from the facsimile machine 12A to the facsimile machine 22A, in the process (6), the facsimile machine 12A carries out the connection demand to the relay server 4 by specifying the user ID of the facsimile machine 22A which is demanded for the connection. Since the facsimile machine 22A is a network device within the local system 2, it cannot obtain the IP address. Therefore, the facsimile machine 22A cannot be specified by the IP address, however, by using this user ID, the facsimile machine 22A can be specified. Further, the user ID of the facsimile machine 22A which is to be the connection destination can be specified by any method such as obtaining it in advance, or specifying it by confirming to the list or the like of the user in the log-in state from the relay server 4. When the facsimile machine 22A corresponding to the specified user ID is not in the log-in state, the relay server 4 returns an error to the facsimile machine 12A. Moreover, when the facsimile machine 22A is under the log-in state, and the connection is vacant, in the process (7), the relay server 4 transmits the connection demand notification including the information that there is the connection demand to the facsimile machine 22A, and the user ID of the facsimile machine 12 A, which is demanding the connection.

The facsimile machine 22A memorize that the connection used for the transmission of the connection demand notification is used in the connection with the facsimile machine 12A, and in the process (8), responds that it is capable of accepting. Further, when rejecting the connection, the facsimile machine 22A sends back an error. In the process (9), the relay server 4 sends back the response from the facsimile machine 22A to the facsimile machine 12A. When the response from the facsimile machine 22A is the response of acceptability, the relay server 4 memorizes that the connection 1 and the connection 2 are to be used in the communication between the facsimile machine 12A and the facsimile machine 22A respectively. Moreover, in the facsimile machine 12A, which received the response from the facsimile machine 22A, when receiving a response that it is capable of accepting, the connection in use (connection 1) is memorized as the connection to be used in the communication with the facsimile machine 22A.

After it is confirmed of carrying out the communication between the facsimile machine 12A and the facsimile machine 22A in the manner stated above, the image is to be transmitted actually after the process (15). Further, in the example shown in FIG. 4, after the communication is decided to be carried out between the facsimile machine 12A and the facsimile machine 22A, for receiving the connection demand from a different facsimile machine and for carrying out the connection demand to a different facsimile machine, a new TCP/IP connection is to be established to the relay server 4 respectively. In other words, in the process (10), the facsimile machine 12A performs the log-in to the relay server 4 to establish the TCP/IP connection (connection 3) with the relay server 4, and in the process (11), the facsimile machine 12A transmits the identifying information such as the user ID and the password to the relay server 4. The relay server 4 carries out the certification of the facsimile machine 12A by the identifying information such as the received user ID and password, and in the process (12), sends back the response. Then, to maintain the connection 3, in the process (13), the connection holding command is transmitted to the relay server 4 from the facsimile machine 12A periodically, and in the process (14), the relay server 4 sends back the response to the facsimile machine 12A. As in the same manner, in the process (10′), the facsimile machine 22A performs the log-in to the relay server 4 to establish the TCP/IP connection (connection 4) with the relay server 4, and in the process (11′), the facsimile machine 22A transmits the identifying information such as the user ID and the password to the relay server 4. The relay server 4 carries out the certification of the facsimile machine 22A by the identifying information such as the received user ID and the password, and in the process (12′), sends back the response. Then, to maintain the connection 4, in the process (13′), the connection holding command is transmitted to the relay server 4 from the facsimile machine 22A periodically, and in the process (14′), the relay server 4 sends back the response to the facsimile machine 22A. Further, in the case where it is not necessary to maintain such vacant connection, the processes of (10)˜(14), or (10′)˜(14′) are not necessary. Moreover, in the case where a plurality of connections has been already secured, these processes are not required.

When it is confirmed of carrying out the communication between the facsimile machine 12A and the facsimile machine 22A by the processes (6)˜(9), in the process (15), the facsimile machine 12A transmits the image to the facsimile machine 22A by using the connection 1 to the relay server 4. The relay server 4 receives the image from the facsimile machine 12A, and in the process (16), transmits the received image to the facsimile machine 22A by using the connection 2. The facsimile machine 22A receives the image from the facsimile machine 12A via the relay server 4 through the connection 2, and in the process (17), transmits the response directed to the facsimile machine 12A to the relay server 4. The relay server 4 receives the response directed to the facsimile machine 12A from the facsimile machine 22A, and transmits the received response to the facsimile machine 12A through the connection 1 in the process (18).

As in the manner stated above, by using the connection 1 between the facsimile machine 12A and the relay server 4, and the connection 2 between the facsimile machine 22A and the relay server 4, and by relaying the data by the relay server 4, the communication can be carried out between the facsimile machine 12A and the facsimile machine 22A. Further, the transmission of the image to the facsimile machine 22A from the facsimile machine 12A by the processes (15)˜(18) can be repeated several times. Moreover, the image can be transmitted from the facsimile machine 22A to the facsimile machine 12A.

When the forwarding of the data between the facsimile machine 12A and the facsimile machine 22A is completed, the termination notification is carried out from the facsimile machine 12A or the facsimile machine 22A. It is to be supposed that the termination notification is carried out from the facsimile machine 12A, and in the process (19), the facsimile machine 12A transmits the termination notification, which is to be transmitted to the facsimile machine 22A, to the relay server 4 by using the connection 1. The relay server 4 transmits the termination notification received from the facsimile machine 12A to the facsimile machine 22A by using the connection 2 in the process (20).

Further, after the facsimile machine 12A and the facsimile machine 22A are connected, the communication procedure up to the termination notification the process (19) is optional, and for example, the procedures in the general real time Internet facsimile machine can be applied.

Then in the process (21), the facsimile machine 12A which transmitted the termination notification transmits the releasing notification indicating that the connection 1 has become vacant to the relay server 4. Moreover, in the process (21′), the facsimile machine 22A which received the termination notification transmits the releasing notification indicating that the connection 2 has become vacant to the relay server 4. Accordingly, the relay server 4 memorizes that the connection 1 and the connection 2 are not to be used in the communication between the facsimile machine 12A and the facsimile machine 22A, and the relay server 4 memorizes and that the connections have become vacant. Further, in this example, the response to the termination notification is not carried out, but it can be made to send back the response.

By carrying out the connection holding command and the response periodically as shown in the process (4), (5), or (4′), (5′), the connection 1 and the connection 2 which were released in such a manner are maintained between the facsimile machine 12A and the relay server 4, and between the facsimile machine 12A and the relay server 4.

Further, at the time being, the connection 1 and the connection 3 are secured between the facsimile machine 12A and the relay server 4. As in the same manner, the connection 2 and the connection 4 are secured between the facsimile machine 22A and the relay server 4. This can be left in this state or the connection 1 and the connection 2 can be disconnected when releasing these connections. Moreover, the connection 3 and the connection 4 can be disconnected while the connection 1 and the connection 2 can be continued.

When the facsimile machine 12A shuts the power source or when stopping the connection to the relay server 4, in the process (22), the facsimile machine 12A notifies the log-out to the relay server 4. At the time being, when a plurality of connections are secured, any connection can be used. Then, the facsimile machine 12A disconnects all the connections. In this example, since two connections, the connection 1 and the connection 3 are secured for the facsimile machine 12A, in the process (23), the connection 1 is to be disconnected to complete and in the process (24), the connection 3 is to be disconnected to complete. The relay server 4 receives the notification of the log-out from the facsimile machine 12A, recognizes the log-out of the facsimile machine 12A and disconnects the connection 1 and the connection 3. Further, it is the same in the facsimile machine 22A.

By carrying out the procedure mentioned above, even in the case where each of or one of the devices is the facsimile machine within the local system, the communication can be carried out. Further, the procedure for carrying out the connection with the relay server 4 as described above, the maintenance of the connection, the connection demand to the facsimile machine, the data transmission to the facsimile machine, the termination of the connection with the facsimile machine, and the termination of the connection with the relay server, can be realized not to give any influence while transparency of the command or the data to be exchanged by the application protocol working in the upper state is maintained, and the communication can be carried out by using the existing application protocol as it is.

What is claimed is:

1. A relay server comprising:
communicating means capable of communicating with a plurality of network devices; and
connection information holding means for holding connection information of the network devices capable of communicating by the communicating means,
wherein the communicating means carries out communication with the network devices in accordance with the connection information, and relays data forwarding between the specified network devices in accordance with connection demand information generated from one of the network devices.

2. A communication system comprising:
a plurality of network devices; and
a relay server connected to the plurality of network devices by a network,
wherein the first network device establishes a communication path with the relay server, and generates a connection demand for communication with the second network device to the relay server when communicating with the second network device, and
the relay server relays the communication between the first and second network devices by using the communication path established in advance in accordance with the connection demand from the first network device.

3. A communication system according to claim 2 wherein the first network device is located in a local system, and connection to the first network device from an outside of the local system is limited.

4. A communication system according to claim 2 wherein the first network device is connected to the relay server via a gateway device having an address converting function.

5. A facsimile system comprising:
a facsimile machine connected to an inner network;
a gateway device for connecting the inner network to an outer network; and
a relay server connected to the outer network for relaying communication between the gateway device and another gateway device,
wherein the facsimile machine transmits and receives image data by being connected to the relay server via the gateway device in advance.

6. A facsimile system according to claim 5 wherein the relay server manages the facsimile machine to be connected in accordance with identifying information specific to the facsimile machine.

7. A facsimile system according to claim 5 wherein a plurality of facsimile machines within the inner network and another inner network can be connected to the relay server via the gateway device and the another gateway device, and the relay server manages each of the plurality of facsimile machines to be connected in accordance with identifying information specific to each of the plurality of facsimile machines.
